(19) United States
(12) Patent Application Publication
(10) Pub. No.: US 2015/0288429 A1
(43) Pub. Date: Oct. 8, 2015

(54) METHOD AND APPARATUS OF DATA TRANSMISSION FOR COOPERATION COMMUNICATION

(71) Applicant: Electronics and Telecommunications Research Institute, Daejeon (KR)

(72) Inventors: Kyung Yeol SOHN, Daejeon (KR); Hoon LEE, Daejeon (KR); Seung Jae BAHNG, Daejeon (KR)

(21) Appl. No.: 14/623,692

(22) Filed: Feb. 17, 2015

(30) Foreign Application Priority Data
Apr. 7, 2014 (KR) 10-2014-0041006

(51) Int. Cl. H04B 7/02; H04B 7/155; H04L 1/06; H04L 5/00

(52) U.S. Cl. CPC H04B 7/026; H04L 5/0023; H04L 5/0032; H04B 7/15521; H04L 1/0625; H04L 1/0643; H04L 1/0662

(57) ABSTRACT

Disclosed are a method and an apparatus for data transmission that apply a transmission diversity method which does not decrease transmission rate even when the number of transmission antennas is 3 or more for frequency division multiplexing scheme downlink cooperation communication to allow a terminal to have an excellent diversity characteristic.

### CROSS-REFERENCE TO RELATED APPLICATIONS

This application claims priority to and the benefit of Korean Patent Application No. 10-2014-0041006 filed in the Korean Intellectual Property Office on Apr. 7, 2014, the entire contents of which are incorporated herein by reference.

### TECHNICAL FIELD

The present invention relates to downlink cooperation communication using orthogonal frequency division multiplexing (OFDM) scheme, and particularly, to a method and an apparatus of data transmission for downlink cooperation communication, which increase transmission diversity efficiency by applying space-frequency block code (SFBC) encoding and quasi-orthogonal encoding.

### BACKGROUND ART

In a next-generation multimedia communication system which has been actively researched in recent years, as there is a demand for a high-speed communication system capable of processing and transmitting various pieces of information including a video, radio data, and the like by deviating from an initial voice centered service, it is required to increase the efficiency of the system by using an appropriate channel encoding scheme.

Since an orthogonal frequency division multiplexing (OFDM) scheme has an advantage of easily coping with a serious frequency-selective fading channel which occurs by multiple paths in the case of intending to transmit data at high speed in a radio channel, the OFDM scheme is adopted as a transmission scheme of various high-speed wireless communication system. Further, a cooperation diversity protocol for general cooperation communication uses divided orthogonal channels including a time slot, a frequency band, and the like on a transmission channel and in this case, since a high diversity degree is required, bandwidth efficiency becomes very low.

In the OFDM system, a research into a transmission diversity technique using multi antennas at a transmitting unit has been actively made in recent years in order to solve a high link budget required in a wireless Internet, and the like. In order to apply a transmission diversity scheme using the multi antennas to the OFDM system, the transmission diversity scheme using the multi antennas may be divided into an STBC-OFDM scheme in which the existing space-time block code (STBC) encoded by using time and space is modified to a form to be encoded into time and space in respect to each sub-carrier and an SFBC-OFDM scheme in which the existing space-time block code (STBC) is encoded by frequency and space for each time, and the respective schemes are methods capable of epochally improving transmission and reception performance without additional frequency allocation or an increase of transmission power as means of combining advantages of transmission antenna diversity and the OFDM. However, since the SFBC-OFDM scheme is a multi-carrier scheme that is resistant to a frequency-selective fading environment as compared with the STBC-OFDM scheme, while applying a block code to adjacent sub-carriers, there is a limit that performance should be guaranteed only when channel states of the adjacent sub-carriers should be the same as each other.

Further, a space-time bloc code (STBC) proposed by Alamouti is proposed as a scheme using two antennas at the transmitting unit and thereafter, the transmission antenna is extended to be applied to three or four transmission antennas by Tarokh. However, both the Alamouti scheme and the schemes proposed by Tarokh have an advantage that signal decoding is possible only by a simple linear calculation by using an orthogonal code, while having a disadvantage that transmission rate decreases when the number of transmission antennas is 3 or more. Accordingly, in order to use the transmission antenna diversity suitable for the downlink cooperation communication using the OFDM scheme, the necessity for the development of other methods in which the transmission rate does not decrease even when the number of transmission antennas is 3 or more is required.

### SUMMARY OF THE INVENTION

The present invention has been made in an effort to provide a method and an apparatus of data transmission that have a diversity characteristic which is excellent in a terminal that performs reception by applying a transmission diversity method that does not decrease transmission rate even when the number of transmission antennas is 3 or more for downlink cooperation communication of a frequency division multiplexing scheme.

An exemplary embodiment of the present invention provides a method for data transmission using antenna diversity in a system for downlink cooperation communication using an orthogonal frequency division multiplexing (OFDM) scheme, including: transmitting, by a base station, a signal acquired by space-frequency block code (SFBC) encoding an input signal to one or more relays during a first time slot interval; and simultaneously transmitting, by the base station and the one or more relays, a signal acquired by quasi-orthogonally encoding the input signal to a destination.

In the transmitting of the signal to the one or more relays, the base station may transmit different signals depending on SFBC encoding by using a plurality of two or more antennas, respectively.

In the simultaneously transmitting of the signal to the destination, different signals depending on quasi-orthogonal encoding may be transmitted by using respective antennas of a plurality of two or more relays.

The simultaneously transmitting of the signal to the destination may include quasi-orthogonally encoding the input signals x₁, x₂, x₃, and x₄ by using the following matrix,

$$[ \begin{matrix}{x}_{1} & - {x}_{2}^{*} \\ {x}_{2} & {x}_{1}^{*} \\ {x}_{3} & - {x}_{4}^{*} \\ {x}_{4} & {x}_{3 }^{*}\end{matrix} ]$$

where, (.)* may mean a complex conjugate operation, a row of the matrix may correspond to an OFDM tone, and a column of the matrix may correspond to an antenna of the base station.

The simultaneously transmitting of the signal to the destination may include quasi-orthogonally encoding the input signals x₁, x₂, x₃, and x₄ by using the following matrix,

$$[ \begin{matrix}{x}_{1} + {x}_{3} & - {x}_{2}^{*} - {x}_{4}^{*} & {x}_{3} - {x}_{1} & {x}_{2}^{*} - {x}_{4}^{*} \\ {x}_{2} + {x}_{4} & {x}_{1}^{*} + {x}_{3}^{*} & {x}_{4} - {x}_{2} & {x}_{3}^{*} - {x}_{1}^{*} \\ {x}_{3} - {x}_{1} & {x}_{2}^{*} - {x}_{4}^{*} & {x}_{1} + {x}_{3} & - {x}_{2}^{*} - {x}_{4}^{*} \\ {x}_{4} - {x}_{2} & {x}_{3}^{*} - {x}_{1}^{*} & {x}_{2} + {x}_{4} & {x}_{1}^{*} + {x}_{3}^{*}\end{matrix} ]$$

where, (.)* may mean the complex conjugate operation, the row of the matrix may correspond to the OFDM tone, and the column of the matrix may correspond to two antennas of the base station and respective antennas of two relays.

A third column of the matrix may correspond to the antenna of the relay between the two relays, which first accesses the base station and a fourth column of the matrix corresponds to the antenna of the relay between the two relays, which accesses the base station later.

The simultaneously transmitting of the signal to the destination may include quasi-orthogonally encoding the input signals x₁, x₂, x₃, and x₄ by using the following matrix,

$$[ \begin{matrix}{x}_{1} + {x}_{3} & - {x}_{2}^{*} - {x}_{4}^{*} & {x}_{3} - {x}_{1} \\ {x}_{2} + {x}_{4} & {x}_{1}^{*} + {x}_{3}^{*} & {x}_{4} - {x}_{2} \\ {x}_{3} - {x}_{1} & {x}_{2}^{*} - {x}_{4}^{*} & {x}_{1} + {x}_{3} \\ {x}_{4} - {x}_{2} & {x}_{3}^{*} - {x}_{1}^{*} & {x}_{2} + {x}_{4}\end{matrix} ]$$

where, (.)* may mean the complex conjugate operation, the row of the matrix may correspond to the OFDM tone, and the column of the matrix may correspond to two antennas of the base station and the antenna of one relay.

Another exemplary embodiment of the present invention provides a transmitter of data for downlink cooperation communication using an orthogonal frequency division multiplexing (OFDM) scheme, including: a symbol mapper creating a complex symbol by modulating an input signal; an SFBC and quasi-orthogonal encoder creating a space-frequency block code (SFBC) encoded signal by using the complex signal during a first time slot interval and creating a quasi-orthogonally encoded signal by using the complex signal during a second time slot interval; One or more IFFT processing units inverse fast Fourier transform (IFFT) transforming the SFBC-encoded signal and IFFT transforming the quasi-orthogonally encoded signal during the second time slot interval; and CP inserting units inserting respective cyclic prefixes (CPs) to correspond to the one or more IFFT processing units. The transmitter may be included in a base station.

The transmitter of the base station may transmit the SFBC encoded signal to one or more relays, and the transmitter and the one or more relays may simultaneously transmit the quasi-orthogonally encoded signal to a destination.

Yet another exemplary embodiment of the present invention provides a transmitter of data for downlink cooperation communication using an orthogonal frequency division multiplexing (OFDM) scheme, including: a symbol mapper creating a complex symbol by modulating an input signal; a quasi-orthogonal encoder creating a quasi-orthogonally encoded signal by using the complex symbol; an IFFT processing unit IFFT transforming the quasi-orthogonally encoded signal; and a CP inserting unit inserting a cyclic prefix (CP) into an output of the IFFT processing unit, wherein the input signal is included in a space-frequency block code (SFBC) encoded signal received from a base station during a first time slot interval and is used to transmit the quasi-orthogonally encoded signal during a second time slot interval. The transmitter may be included in a relay.

The base station may transmit the SFBC encoded signal to one or more relays, and the base station and the relay may simultaneously transmit the quasi-orthogonally encoded signal to a destination.

The destination may be a terminal that receives an OFDM downlink signal, and the terminal includes a CP removing unit removing a cyclic prefix (CP) from a received signal; a linear decoder decoding a signal received from the FFT processing unit to create corresponding complex symbols; and a symbol demapper demapping the complex symbols to restore data.

According to exemplary embodiments of the present invention, in a method and an apparatus of data transmission for downlink cooperation communication, a base station transmits a signal to a relay side by using SFBC encoding during a first time slot for orthogonal frequency division multiplexing (OFDM) scheme downlink cooperation communication and the base station and one or two relays use transmission antenna diversity that simultaneously transmits data to a destination by using quasi-orthogonal encoding during a second time slot to contribute to communication in which data transmission rate is improved and is reliable due to a diversity gain acquired by a terminal that receives the signal.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a diagram illustrating a first time slot and a second time slot for OFDM scheme downlink cooperation communication according to an exemplary embodiment of the present invention.

FIG. 2 is a diagram illustrating a first time slot and a second time slot with other concepts for OFDM scheme downlink cooperation communication according to an exemplary embodiment of the present invention.

FIG. 3 is an encoding conceptual diagram of a transmitted signal for the OFDM scheme downlink cooperation communication according to the exemplary embodiment of the present invention.

FIG. 4 is an encoding conceptual diagram of a transmitted signal with another concept for the OFDM scheme downlink cooperation communication according to the exemplary embodiment of the present invention.

FIG. 5 is a configuration diagram schematically illustrating a transmitter of a base station for the OFDM scheme downlink cooperation communication according to the exemplary embodiment of the present invention.

FIG. 6 is a flowchart for describing an operation of the transmitter of the base station of FIG. 5.

FIG. 7 is a configuration diagram schematically illustrating a transmitter of a relay for the OFDM scheme downlink cooperation communication according to the exemplary embodiment of the present invention.

FIG. 8 is a flowchart for describing an operation of the transmitter of the relay of FIG. 7.

FIG. 9 is a configuration diagram schematically illustrating a receiver of a terminal for the OFDM scheme downlink cooperation communication according to the exemplary embodiment of the present invention.

FIG. 10 is a flowchart for describing an operation of the receiver of the terminal of FIG. 7.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described by priority and a description of elements which may obscure the spirit of the present invention will be skipped.

Further, some components of the drawings may be enlarged, omitted, or schematically illustrated. An actual size is not fully reflected on the size of each component and therefore, contents disclosed herein are not limited by relative sizes or intervals of the components drawn in the respective drawings.

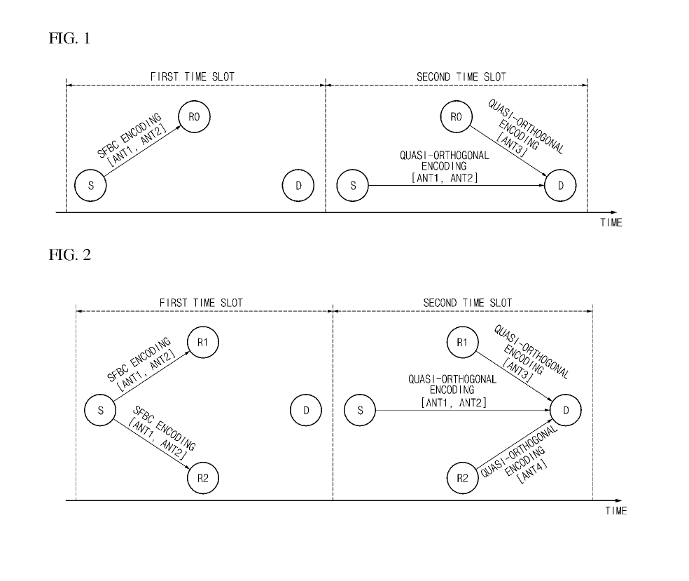

FIG. 1 is a diagram illustrating a first time slot and a second time slot for OFDM scheme downlink cooperation communication according to an exemplary embodiment of the present invention.

The system for the downlink cooperation communication in the OFDM scheme of the present invention includes a base station S, a relay R0, and a terminal D. Herein, the base station S includes at least two antennas, the relay R0 includes one antenna, and the terminal D includes one antenna. Herein, the relay R0 may be a small-cell base station, a femto-cell base station, or a user terminal which may relay a signal between the base station S and the terminal D. The terminal D may be various terminals that may receive an OFDM scheme downlink signal, which include a smart phone, a tablet PC, a notebook PC, and the like.

In FIG. 1, during a first time slot interval, the base station S transmits an SFBC encoded signal to the relay R0 through two antennas ANT1 and ANT2, during a second time slot interval, the base station S retransmits a corresponding quasi-orthogonally encoded signal to the terminal D as a destination through two antennas ANT1 and ANT2, and the relay R0 retransmits the corresponding quasi-orthogonally encoded signal created by using the signal received during the first time slot interval to the terminal D as the destination through one antenna ANT3.

FIG. 2 is a diagram illustrating a first time slot and a second time slot with other concepts for OFDM scheme downlink cooperation communication according to an exemplary embodiment of the present invention.

In FIG. 2, the system for the downlink cooperation communication in the OFDM scheme of the present invention includes the base station S, a plurality of (e.g., two) relays R1 and R2, and the terminal D. Herein, the base station S includes at least two antennas, each of the relays R1 and R2 includes one antenna, and the terminal D includes one antenna. Eve herein, the relays R1 and R2 may be the small-cell base station, the femto-cell base station, or the user terminal which may relay the signal between the base station S and the terminal D. The terminal D may various terminals that may the OFDM scheme downlink signal, which include the smart phone, the tablet PC, the notebook PC, and the like.

In FIG. 2, during the first time slot interval, the base station S transmits the SFBC encoded signal to the relays R1 and R2 through two antennas, during the second time slot interval, the base station S retransmits the corresponding quasi-orthogonally encoded signal to the terminal D as the destination through two antennas ANT1 and ANT2, and each of the relays R1 and R2 retransmits the corresponding quasi-orthogonally encoded signal created by using the signal received during the first time slot interval to the terminal D as the destination through one antenna ANT3/ANT4.

First, concepts of the SFBC encoding and the quasi-orthogonal encoding of transmitted signals of the base station S and one or more relays (e.g., R0, R1, and R2) (R) to be applied to the system for the OFDM scheme downlink cooperation communication of the present invention will be described below.

A signal is encoded in an Alamouti scheme space frequency scheme by using a 2×2 matrix as shown in [Table 1].

TABLE 1

| | Antenna 1 | Antenna 2 |
|---|---|---|
| OFDM Tone 1 | x₁ | −x₂* |
| OFDM Tone 2 | x₂ | −x₁* |

That is, when two antennas are used in a transmitting unit, a first transmission antenna transmits a signal without a change and only a signal transmitted through a second antenna is encoded. However, since this scheme has a disadvantage that the number of transmission antennas is limited to two in order to acquire complete encoding rate and an optimal diversity gain, the 2×2 matrix given in [Table 1] is extended to a 4×2 matrix as shown in [Equation 1] to be used as a basic matrix for encoding a signal transmitted from the base station S to the relay R for the downlink cooperation communication as described in the present invention. Herein, (.)* means a complex conjugate operation, a row (element) corresponds to an OFDM tone, and a column (element) corresponds to the transmission antenna (e.g., ANT1/ANT2). That is, the corresponding SFBC encoded signal may be transmitted through the respective antennas in respective tones of a plurality of (e.g., four) subcarrier frequencies at the same time.

$$[ \begin{matrix}{x}_{1} & - {x}_{2}^{*} \\ {x}_{2} & {x}_{1}^{*} \\ {x}_{3} & - {x}_{4}^{*} \\ {x}_{4} & {x}_{3}^{*}\end{matrix} ] \qquad [ Equation 1 ]$$

As the number of transmission antennas (e.g., ANT1/ANT2/ANT3/ANT4) that transmit the signal to the terminal D from the base station S and the relay R involved in the downlink cooperation communication, three or more transmission antennas are used and to this end, various schemes using an orthogonal code are proposed. However, the schemes also have a disadvantage that transmission rate decreases when the number of antennas is 3 or more. Accordingly, in order to remedy the disadvantage, in the present invention, a quasi-orthogonal code in which the encoding rate defined as shown in [Equation 2] is 1 is used in the downlink cooperation communication. Herein, (.)* means the complex conjugate operation, the row (element) corresponds to the OFDM tone, and the column (element) corresponds to the transmission antenna (e.g., ANT1/ANT2/ANT3/ANT4). That is, the corresponding quasi-orthogonally encoded signal may be transmitted through the respective antennas in the respective tones of the plurality of (e.g., four) subcarrier frequencies at the same time.

$$[ \begin{matrix}{x}_{1} + {x}_{3} & - {x}_{2}^{*} - {x}_{4}^{*} & {x}_{3} - {x}_{1} & {x}_{2}^{*} - {x}_{4}^{*} \\ {x}_{2} + {x}_{4} & {x}_{1}^{*} + {x}_{3}^{*} & {x}_{4} - {x}_{2} & {x}_{3}^{*} - {x}_{1}^{*} \\ {x}_{3} - {x}_{1} & {x}_{2}^{*} - {x}_{4}^{*} & {x}_{1} + {x}_{3} & - {x}_{2}^{*} - {x}_{4}^{*} \\ {x}_{4} - {x}_{2} & {x}_{3}^{*} - {x}_{1}^{*} & {x}_{2} + {x}_{4} & {x}_{1}^{*} + {x}_{3}^{*}\end{matrix} ] \qquad [ Equation 2 ]$$

The quasi-orthogonal code given in [Equation 2] above is the 4×4 matrix applied when the number of transmission antennas used for the cooperation communication is 4 (e.g., ANT1, ANT2, ANT3, and ANT4) and a 4×3 matrix is used, in which a last column corresponding to a 4-th antenna is deleted as shown in [Equation 3] when the number of transmission antennas is 3 (e.g., ANT1, ANT2, and ANT3).

$$[ \begin{matrix}{x}_{1} + {x}_{3} & - {x}_{2}^{*} - {x}_{4}^{*} & {x}_{3} - {x}_{1} \\ {x}_{2} + {x}_{4} & {x}_{1}^{*} + {x}_{3}^{*} & {x}_{4} - {x}_{2} \\ {x}_{3} - {x}_{1} & {x}_{2}^{*} - {x}_{4}^{*} & {x}_{1} + {x}_{3} \\ {x}_{4} - {x}_{2} & {x}_{3}^{*} - {x}_{1}^{*} & {x}_{2} + {x}_{4}\end{matrix} ] \qquad [ Equation 3 ]$$

In the system of the present invention, two antennas ANT1 and ANT2 of the base station S are exemplified, but the number of antennas is not limited thereto and the base station S may include one antenna or more antennas and further, as the relay, one relay R0 or two relays R1 and R2 may also be exemplified, but the example of the relay is not limited thereto and the relay may include more relays and in this case, a matrix for SFBC encoding and a matrix for quasi-orthogonal encoding may be used as slightly modified forms of [Equation 1] and [Equation 2] according to the number of the corresponding antennas.

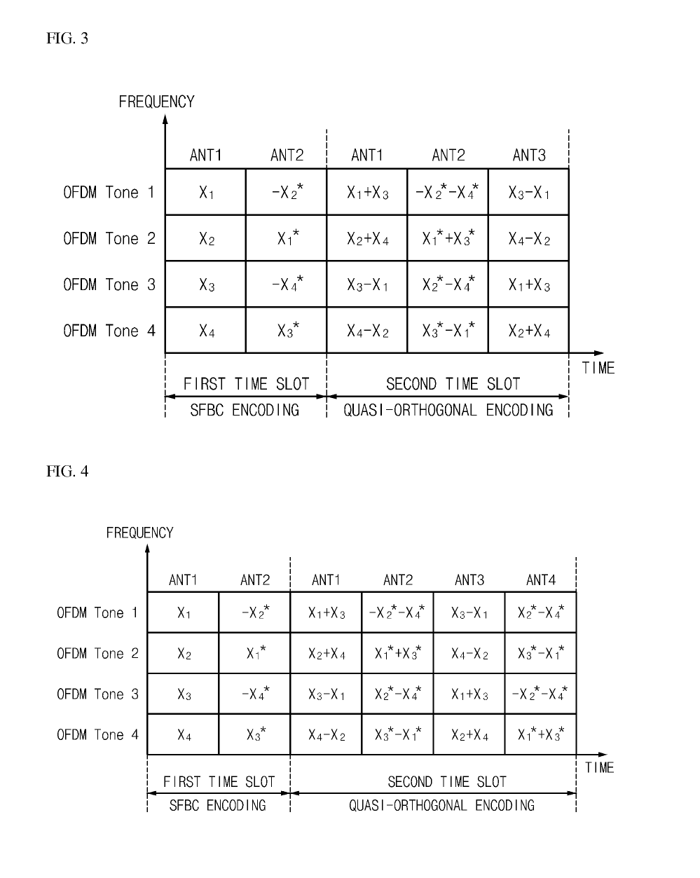

FIG. 3 is an encoding conceptual diagram of a transmitted signal for the OFDM scheme downlink cooperation communication according to the exemplary embodiment of the present invention. FIG. 3 illustrates concepts of encoding the transmitted signal of the base station S having two antennas ANT1 and ANT2 during the first time slot interval and encoding of the transmitted signals of the base station S and the relay R0 having one antenna ANT3 during the second time slot interval as illustrated in FIG. 1.

As illustrated in FIG. 3, the base station S performs SFBC encoding of a transmission target input signal by using a 4×2 matrix of [Equation 1] during the first time slot interval and transmits the SFBC-encoded signal to the relay R0 through two antennas ANT1 and ANT2.

Further, the base station S and the relay R0 simultaneously perform quasi-orthogonal encoding of an input signal by using a 4×3 matrix as illustrated in [Equation 3] during the second time slot interval, however, the base station S retransmits the signal acquired by quasi-orthogonally encoding the input signal to the terminal D as the destination through two antennas ANT1 and ANT2 and the relay R0 retransmits the signal acquired by quasi-orthogonally encoding the input signal to the terminal D as the destination through one antenna ANT3 by using the signal received during the first time slot interval.

The respective antennas ANT1, ANT2, and ANT3 are fixed to use a corresponding encoding rule during each time slot interval as illustrated in FIG. 3.

FIG. 4 is an encoding conceptual diagram of a transmitted signal with another concept for the OFDM scheme downlink cooperation communication according to the exemplary embodiment of the present invention. FIG. 4 illustrates concepts of encoding the transmitted signal of the base station S having two antennas ANT1 and ANT2 during the first time slot interval and encoding of the transmitted signal of the base station S and each of the relays R1 and R2 having one antenna ANT3/ANT4 during the second time slot interval as illustrated in FIG. 2.

As illustrated in FIG. 4, the base station S performs SFBC encoding of the transmission target input signal by using the 4×2 matrix of [Equation 1] during the first time slot interval and transmits the SFBC-encoded signal to the relays R1 and R2 through two antennas ANT1 and ANT2.

Further, the base station S and the relays R1 and R2 simultaneously perform quasi-orthogonal encoding by using the 4×4 matrix of [Equation 2] during the second time slot interval, however, the base station S retransmits the signal acquired by quasi-orthogonally encoding the transmission target input signal to the terminal D as the destination through two antennas ANT1 and ANT2 and the relays R1 and R2 retransmit the signal acquired by quasi-orthogonally encoding the input signal to the terminal D as the destination through the respective antennas ANT3 and ANT4, respectively by using the signal received during the first time slot interval.

The respective antennas ANT1 and ANT2 of the base station S are fixed to use the corresponding encoding rule during each time slot interval as illustrated in FIG. 3. However, a relay between the relays R1 and R2, which first accesses the base station S according to an access order to the base station S is subjected to the downlink cooperation communication using the encoding rule of the ANT3. The relay between the relays R1 and R2, which preferentially accesses the base station S becomes the relay R1 using an element of the encoding rule of the ANT3 and the relay that accesses the base station S thereafter becomes the relay R2 using an element of the encoding rule corresponding to the ANT4.

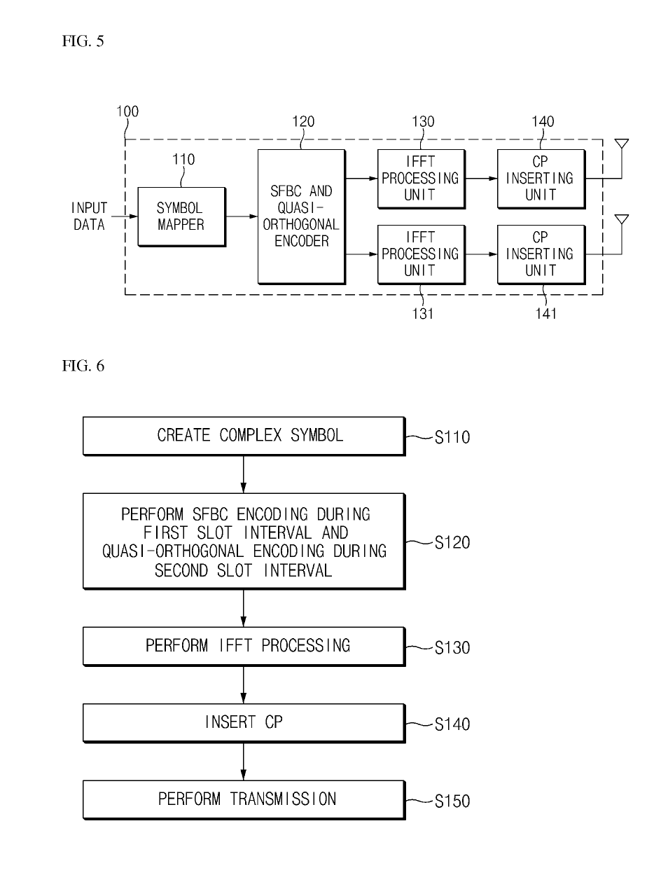

FIG. 5 is a configuration diagram schematically illustrating a transmitter 100 of a base station S for the OFDM scheme downlink cooperation communication according to the exemplary embodiment of the present invention. Operations of the SFBC encoding and the quasi-orthogonal encoding of the transmitter 100 of the base station S will be described with reference to a flowchart of FIG. 6.

Referring to FIG. 5, the transmitter 100 of the base station S according to the exemplary embodiment of the present invention may include a symbol mapper 110, an SFBC and quasi-orthogonal encoder 120, a first IFFT processing unit 130, a second IFFT processing unit 131, a first CP inserting unit 140, and a second CP inserting unit 141.

The symbol mapper 110 modulates the transmission target input signal (alternatively, data) x₁/x₂/x₃/x₄ according to a predetermined modulation scheme to output a complex symbol (5110). For example, the complex symbol such as a QPSK symbol or a QAM symbol is created by using a QPSK modulation scheme or a QAM modulation scheme to be transferred to the SFBC and quasi-orthogonal encoder 120.

The SFBC and quasi-orthogonal encoder 120 creates the SFBC encoded signal of the input signal according to [Equation 1] by using the complex symbol during the first time slot interval and creates the quasi-orthogonally encoded signal according to [Equation 2] by using the complex symbol during the second time slot interval (S120).

For example, the SFBC and quasi-orthogonal encoder 120 may perform the SFBC encoding of the transmission target input signal by using the 4×2 matrix of [Equation 1] during the first time slot interval and the quasi-orthogonal encoding by using the 4×3 matrix as illustrated in [Equation 3] during the second time slot interval, as illustrated in FIG. 3 in the system of FIG. 1.

Alternatively, in the case of FIG. 4 in the system of FIG. 2, the SFBC and quasi-orthogonal encoder 120 may perform the SFBC encoding of the transmission target input signal by using the 4×2 matrix of [Equation 1] during the first time slot interval and the quasi-orthogonal encoding by using the 4×4 matrix of [Equation 2] during the second time slot interval.

The first IFFT processing unit 130 and the second IFFT processing unit 131 transform the signal input by the SFBC and quasi-orthogonal encoder 120, that is, the SFBC encoded signal during the first time slot interval or the quasi-orthogonally encoded signal during the second time slot interval into a time domain signal through inverse fast Fourier transform (IFFT) (S130).

The first CP inserting unit 140 and the second CP inserting unit 141 insert cyclic prefixes (CPs) into the signal transformed into the time domain by the first IFFT processing unit 130 and the second IFFT processing unit 131, respectively (S140) and the respective signals inserted with the cyclic prefixes are transmitted through two antennas, respectively (S150).

Herein, it is exemplified that the IFFT processing units 130 and 131 and the CP inserting units 140 and 141 are each provided in two, but IFFT processing units and CP inserting units as many as the corresponding antennas may be used in order to transmit the signal through more antennas.

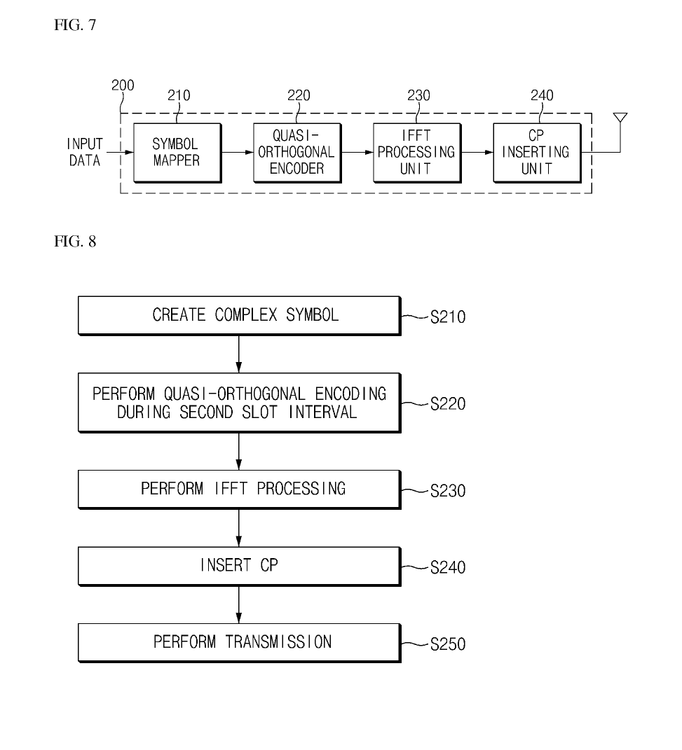

FIG. 7 is a configuration diagram schematically illustrating a transmitter 200 of a relay R0/R1/R2 for the OFDM scheme downlink cooperation communication according to the exemplary embodiment of the present invention. An operation of quasi-orthogonal encoding of the transmitter 200 of the relay R0/R1/R2 will be described with reference to a flowchart of FIG. 8.

Referring to FIG. 7, the transmitter 200 of the relay R0/R1/R2 according to the exemplary embodiment of the present invention may include a symbol mapper 210, a quasi-orthogonal encoder 220, an IFFT processing unit 230, and a CP inserting unit 240.

The symbol mapper 210 uses the transmission target input signal among the signals received by the transmitter 100 of the base station S during the first time slot interval as the input signal during the second time slot interval to output the complex symbol through modulation according to a predetermined modulation scheme. For example, the complex symbol such as the QPSK symbol or the QAM symbol is created by using the QPSK modulation scheme or the QAM modulation scheme to be transferred to the quasi-orthogonal encoder 220.

The quasi-orthogonal encoder 220 creates the quasi-orthogonally encoded signal according to [Equation 2] during the second time slot interval by using the complex symbol (S220).

For example, the quasi-orthogonal encoder 220 may perform the quasi-orthogonal encoding by using the 4×3 matrix as shown in [Equation 3] during the second time slot interval as illustrated in FIG. 3 in the system of FIG. 1 or by using the 4×4 matrix of [Equation 2] during the second time slot interval as illustrated in FIG. 4 in the system of FIG. 2.

The IFFT processing unit 230 transforms the signal (quasi-orthogonally encoded signal) input by the quasi-orthogonal encoder 220 into the time domain signal through the inverse fast Fourier transform (IFFT) (S230).

The CP inserting unit 240 inserts a cyclic prefix (CP) into the signal transformed into the time domain by the IFFT processing unit 230 (S240) and transmits the signal inserted with the CP through the antenna (S250).

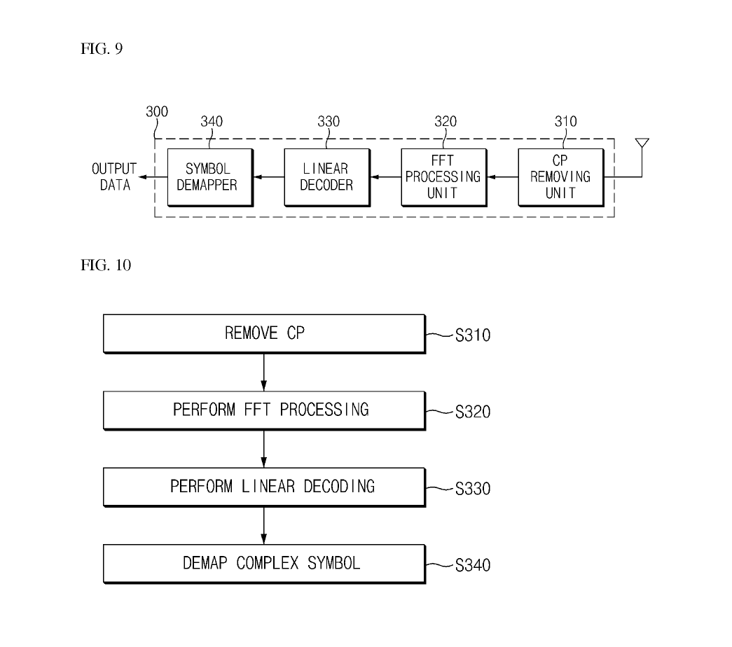

FIG. 9 is a configuration diagram schematically illustrating a transmitter 300 of a terminal D for the OFDM scheme downlink cooperation communication according to the exemplary embodiment of the present invention. A decoding operation of the receiver 300 of the terminal D will be described with reference to a flowchart of FIG. 10.

Referring to FIG. 9, the receiver 300 of the terminal D according to the exemplary embodiment of the present invention may include a CP removing unit 310, an FFT processing unit 320, a linear decoder 330, and a symbol demapper 340.

The CP removing unit 310 removes the cyclic prefix (CP) from a signal received through a receiving antenna (S310). Since the cyclic prefix (CP) is inserted to cope with symbol interference by a signal delay, the CP is removed and appropriately processed to be firstly removed in order to acquire a symbol without symbol interference.

The FFT processing unit 320 transforms a signal output from the CP removing unit 310 into a frequency domain signal through fast Fourier transform (FFT) and the transformed signal is transferred to the linear decoder 330 (S320).

The linear decoder 330 decodes the frequency domain signal received from the FFT processing unit 320 to create corresponding complex symbols and the complex symbols output from the linear decoder 330 are output to the symbol demapper 340 (S330).

The symbol demapper 340 demaps (e.g., the QPSK scheme, the QAM scheme, and the like) the complex symbols output from the linear decoder 330 to restore original transmitted data (S340). In this case, as the symbol demapper 340, a maximum likelihood detector may be used, but the present invention is not limited thereto and another detection technique may be, of course, used.

The present invention has been described by specified matters such as specific components and limited exemplary embodiments and drawings in the exemplary embodiment of the present invention as described above, this is just provided to assist more overall appreciation and the present invention is not limited to the exemplary embodiment. Various modifications and transforms can be made by those skilled in the art within the scope without departing from an essential characteristic of the present invention. The spirit of the present invention is defined by the appended claims rather than by the description preceding them, and the claims to be described below and it should be appreciated that all technical spirit which are evenly or equivalently modified are included in the claims of the present invention.

What is claimed is:

1. A method for data transmission using antenna diversity in a system for downlink cooperation communication using an orthogonal frequency division multiplexing (OFDM) scheme, the method comprising:
transmitting, by a base station, a signal acquired by space-frequency block code (SFBC) encoding an input signal to one or more relays during a first time slot interval; and
simultaneously transmitting, by the base station and the one or more relays, a signal acquired by quasi-orthogonally encoding the input signal to a destination.

2. The method of claim 1, wherein in the transmitting of the signal to the one or more relays, the base station transmits different signals depending on SFBC encoding by using a plurality of two or more antennas, respectively.

3. The method of claim 1, wherein in the simultaneously transmitting of the signal to the destination, different signals depending on quasi-orthogonal encoding are transmitted by using respective antennas of a plurality of two or more relays.

4. The method of claim 1, wherein:
the transmitting of the signal to the one or more relays includes SFBC-encoding input signals x₁, x₂, x₃, and x₄ by using the following matrix,
$$[ \begin{matrix}{x}_{1} & - {x}_{2}^{*} \\ {x}_{2} & {x}_{1}^{*} \\ {x}_{3} & - {x}_{4}^{*} \\ {x}_{4} & {x}_{3}^{*}\end{matrix} ]$$
where, (.)* means a complex conjugate operation, a row of the matrix corresponds to an OFDM tone, and a column of the matrix corresponds to an antenna of the base station.

5. The method of claim 1, wherein:
the simultaneously transmitting of the signal to the destination includes quasi-orthogonally encoding the input signals x₁, x₂, x₃, and x₄ by using the following matrix,
$$[ \begin{matrix}{x}_{1} + {x}_{3} & - {x}_{2}^{*} - {x}_{4}^{*} & {x}_{3} - {x}_{1} & {x}_{2}^{*} - {x}_{4}^{*} \\ {x}_{2} + {x}_{4} & {x}_{1}^{*} + {x}_{3}^{*} & {x}_{4} - {x}_{2} & {x}_{3}^{*} - {x}_{1}^{*} \\ {x}_{3} - {x}_{1} & {x}_{2}^{*} - {x}_{4}^{*} & {x}_{1} + {x}_{3} & - {x}_{2}^{*} - {x}_{4}^{*} \\ {x}_{4} - {x}_{3} & {x}_{3}^{*} - {x}_{1}^{*} & {x}_{2} + {x}_{4} & {x}_{1}^{*} + {x}_{3}^{*}\end{matrix} ]$$
where, (.)* means the complex conjugate operation, the row of the matrix corresponds to the OFDM tone, and the column of the matrix corresponds to two antennas of the base station and respective antennas of two relays.

6. The method of claim 5, wherein a third column of the matrix corresponds to the antenna of the relay between the two relays, which first accesses the base station and a fourth column of the matrix corresponds to the antenna of the relay between the two relays, which accesses the base station later.

7. The method of claim 1, wherein:
the simultaneously transmitting of the signal to the destination includes quasi-orthogonally encoding the input signals x₁, x₂, x₃, and x₄ by using the following matrix,
$$[ \begin{matrix}{x}_{1} + {x}_{3} & - {x}_{2}^{*} - {x}_{4}^{*} & {x}_{3} - {x}_{1} \\ {x}_{2} + {x}_{4} & {x}_{1}^{*} + {x}_{3}^{*} & {x}_{4} - {x}_{2} \\ {x}_{3} - {x}_{1} & {x}_{2}^{*} - {x}_{4}^{*} & {x}_{1} + {x}_{3} \\ {x}_{4} - {x}_{2} & {x}_{3}^{*} - {x}_{1}^{*} & {x}_{2} + {x}_{4}\end{matrix} ]$$
where, (.)* means the complex conjugate operation, the row of the matrix corresponds to the OFDM tone, and the column of the matrix corresponds to two antennas of the base station and the antenna of one relay.

8. A transmitter of data for downlink cooperation communication using an orthogonal frequency division multiplexing (OFDM) scheme, the transmitter comprising:
a symbol mapper creating a complex symbol by modulating an input signal;
an SFBC and quasi-orthogonal encoder creating a space-frequency block code (SFBC) encoded signal by using the complex signal during a first time slot interval and creating a quasi-orthogonally encoded signal by using the complex signal during a second time slot interval;
one or more IFFT processing units inverse fast Fourier transform (IFFT) transforming the SFBC-encoded signal and IFFT transforming the quasi-orthogonally encoded signal during the second time slot interval; and
CP inserting units inserting respective cyclic prefixes (CPs) to correspond to the one or more IFFT processing units.

9. The transmitter of claim 8, wherein the transmitter is included in a base station.

10. The transmitter of claim 8, wherein the transmitter of the base station transmits the SFBC encoded signal to one or more relays, and the transmitter and the one or more relays simultaneously transmit the quasi-orthogonally encoded signal to a destination.

11. A transmitter of data for downlink cooperation communication using an orthogonal frequency division multiplexing (OFDM) scheme, the transmitter comprising:
a symbol mapper creating a complex symbol by modulating an input signal;
a quasi-orthogonal encoder creating a quasi-orthogonally encoded signal by using the complex symbol;
an IFFT processing unit IFFT transforming the quasi-orthogonally encoded signal; and
a CP inserting unit inserting a cyclic prefix (CP) into an output of the IFFT processing unit,
wherein the input signal is included in a space-frequency block code (SFBC) encoded signal received from a base station during a first time slot interval and is used to transmit the quasi-orthogonally encoded signal during a second time slot interval.

12. The transmitter of claim 11, wherein the transmitter is included in a relay.

13. The transmitter of claim 11, wherein the base station transmits the SFBC encoded signal to one or more relays, and the base station and the relay simultaneously transmit the quasi-orthogonally encoded signal to a destination.

14. The transmitter of claim 13, wherein:
the destination is a terminal that receives an OFDM downlink signal, and
the terminal includes,
a CP removing unit removing a cyclic prefix (CP) from a received signal;
a fast Fourier transform (FFT) processing unit transforming a signal output from the CP removing unit;
a linear decoder decoding a signal received from the FFT processing unit to create corresponding complex symbols; and
a symbol demapper demapping the complex symbols to restore data.

15. The transmitter of claim 11, wherein:
the SFBC encoding is performed for target signals x₁, x₂, x₃, and x₄ by using the following matrix,
$$[ \begin{matrix}{x}_{1} & - {x}_{2}^{*} \\ {x}_{2} & {x}_{1}^{*} \\ {x}_{3} & - {x}_{4}^{*} \\ {x}_{4} & {x}_{3}^{*}\end{matrix} ]$$
where, (.)* means a complex conjugate operation, a row of the matrix corresponds to an OFDM tone, and a column of the matrix corresponds to an antenna of the base station.

16. The transmitter of claim 11, wherein:
the quasi-orthogonally encoding is performed for target signals x₁, x₂, x₃, and x₄ by using the following matrix,
$$[ \begin{matrix}{x}_{1} + {x}_{3} & - {x}_{2}^{*} - {x}_{4}^{*} & {x}_{3} - {x}_{1} & {x}_{2}^{*} - {x}_{4}^{*} \\ {x}_{2} + {x}_{4} & {x}_{1}^{*} + {x}_{3}^{*} & {x}_{4} - {x}_{2} & {x}_{3}^{*} - {x}_{1}^{*} \\ {x}_{3} - {x}_{1} & {x}_{2}^{*} - {x}_{4}^{*} & {x}_{1} + {x}_{3} & - {x}_{2}^{*} - {x}_{4}^{*} \\ {x}_{4} - {x}_{2} & {x}_{3}^{*} - {x}_{1}^{*} & {x}_{2} + {x}_{4} & {x}_{1}^{*} + {x}_{3}^{*}\end{matrix} ]$$
where, (.)* means the complex conjugate operation, the row of the matrix corresponds to the OFDM tone, and the column of the matrix corresponds to two antennas of the base station and respective antennas of two relays.

17. The transmitter of claim 16, wherein a third column of the matrix corresponds to the antenna of the relay between the two relays, which first accesses the base station and a fourth column of the matrix corresponds to the antenna of the relay between the two relays, which accesses the base station later.

18. The transmitter of claim 11, wherein:
the quasi-orthogonally encoding is performed for target signals x₁, x₂, x₃, and x₄ by using the following matrix,
$$[ \begin{matrix}{x}_{1} + {x}_{3} & - {x}_{2}^{*} - {x}_{4}^{*} & {x}_{3} - {x}_{1} \\ {x}_{2} + {x}_{4} & {x}_{1}^{*} + {x}_{3}^{*} & {x}_{4} - {x}_{2} \\ {x}_{3} - {x}_{1} & {x}_{2}^{*} - {x}_{4}^{*} & {x}_{1} + {x}_{3} \\ {x}_{4} - {x}_{2} & {x}_{3}^{*} - {x}_{1}^{*} & {x}_{2} + {x}_{4}\end{matrix} ]$$
where, (.)* means the complex conjugate operation, the row of the matrix corresponds to the OFDM tone, and the column of the matrix corresponds to two antennas of the base station and the antenna of one relay.
